(19) United States
(12) Patent Application Publication
(10) Pub. No.: US 2015/0283965 A1
(43) Pub. Date: Oct. 8, 2015

(54) METHODS AND APPARATUSES FOR TEMPERATURE CONTROL IN ENERGY STORAGE DEVICES

(71) Applicant: MAXWELL TECHNOLOGIES, INC., SAN DIEGO, CA (US)

(72) Inventor: ROBERT SHAW LYNDS, SAN DIEGO, CA (US)

(21) Appl. No.: 14/680,735

(22) Filed: Apr. 7, 2015

Related U.S. Application Data
(60) Provisional application No. 61/976,920, filed on Apr. 8, 2014.

(51) Int. Cl. B60R 16/033; H01M 10/625; H01M 10/6563; H01G 9/10; H01G 2/08; H01G 2/10; H01G 11/06; H01M 2/10; H01M 10/658

(52) U.S. Cl. CPC B60R 16/033; H01M 2/1077; H01M 2/1083; H01M 10/625; H01M 10/6563; H01M 10/658; H01G 2/08; H01G 2/103; H01G 11/06; H01G 9/10; H01M 2220/20

(57) ABSTRACT

An energy storage apparatus can include a plurality of energy storage sub-modules adjacent one another, each of the plurality of energy storage sub-modules including a plurality of prismatic energy storage devices positioned on a carrying tray. An insulator sleeve can surround the plurality of prismatic energy storage devices positioned on the carrying tray and a pair of side plates positioned around the insulator sleeve. A first of the pair of side plates can be placed adjacent a first side of the insulator sleeve and a second of the pair of side plates can be placed adjacent a second opposing side of the insulator sleeve, where at least one of the pair of side plates has a plurality of protrusions distributed across an exterior surface. An air flow generator can be at a distal end of the energy storage apparatus and configure to draw air into and propel air flow through the energy storage apparatus.

### CROSS-REFERENCE TO RELATED APPLICATIONS

This application claims the benefit of U.S. Provisional Patent Application No. 61/976,920, filed Apr. 8, 2014, entitled “METHODS AND APPARATUSES FOR TEMPERATURE CONTROL IN ENERGY STORAGE DEVICES,” the disclosure of which is incorporated herein by reference in its entirety.

### STATEMENT REGARDING FEDERALLY SPONSORED R&D

This invention was supported by DEFC2605NT42403 awarded by the United States Department of Energy. The giovernment has certain rights in the invention.

### INCORPORATION BY REFERENCE TO ANY PRIORITY APPLICATIONS

Any and all applications for which a foreign or domestic priority claim is identified in the Application Data Sheet as filed with the present application are hereby incorporated by reference under 37 CFR 1.57.

### BACKGROUND

1. Field

The present invention relates to energy storage devices, particularly to methods and apparatuses for controlling temperature within an energy storage device.

2. Description of the Related Art

Energy storage devices, such as capacitors, batteries, capacitor-battery hybrids, and/or fuel cells, can be used to power motor vehicles, electronic devices, and/or the like. For example, lithium ion capacitors and/or lithium ion batteries can be used to power motor vehicles and/or electronic devices. However, energy storage devices, such as the lithium ion capacitors and/or lithium ion batteries, can generate a significant amount of heat during their operation. Heat generated during operation of the energy storage devices may result in undesirably high device temperatures, which may adversely impact device performance, such as a device life performance. Therefore, temperature control mechanisms can be beneficial to energy storage devices to facilitate removal of heat away from the energy storage devices during their operation, including during operation of energy storage devices under high voltage conditions.

### SUMMARY

Embodiments of an energy storage system can include a plurality of energy storage sub-modules adjacent one another and configured to be contained within a cover forming a portion of an energy storage module. Each of the plurality of energy storage sub-modules may include a carrying tray having a proximal end and a second opposing distal end, and a plurality of prismatic energy storage devices can be positioned longitudinally along the carrying tray with respect to each other. An insulator sleeve can surround the plurality of prismatic energy storage devices. The energy storage system can include a pair of side plates, a first of the pair of side plates adjacent a first side of the insulator sleeve and a second of the pair of side plates adjacent a second opposing side of the insulator sleeve, where at least one of the pair of side plates includes a plurality of protrusions distributed across an exterior surface. The energy storage module can be configured, in response to a pressure drop across the plurality of sub-modules, to draw air through the cover and propel air flow across the exterior surface of the at least one of the pair of side plates.

In some embodiments, at least one of the plurality of prismatic energy storage devices can include a lithium ion capacitor. In some embodiments, at least one of the plurality of prismatic energy storage devices can include a lithium ion battery.

In some embodiments, the plurality of protrusions is configured to maintain a separation length between adjacent energy storage sub-modules. A ratio of the separation length to an energy storage sub-module length perpendicular in direction to that of the separation length can be about 1:10 to about 1:50.

In some embodiments, at least one of the plurality of prismatic energy storage devices can have a pouch cell configuration. In some embodiments, the insulator sleeve is configured to provide a compressive force upon the at least one of the plurality of prismatic energy storage devices. The energy storage system can include a sealing cap over the insulator sleeve and over the proximal end and the second opposing distal end of the carrying tray, where the sealing caps and the insulator sleeve can hermetically seal the plurality of prismatic energy storage devices within a substantially dust-free environment. In some embodiments, the pair of side plates can be configured to provide a compressive force upon the plurality of prismatic energy storage devices. In some embodiments, the pair of side plates can include a metallic material. For example, the pair of side plates can include aluminum.

In some embodiments, the module is configured to generate an air flow pattern through the module such that the plurality of prismatic energy storage device operates each between a temperature of about 25° C. to about 55° C. In some embodiments, each module can include an air flow generator configured to provide the pressure drop.

Embodiments can include a motor vehicle powered by the energy storage system. In some embodiments, the motor vehicle can include an automobile.

In some embodiments, the energy storage system can be configured to provide an operating voltage of about 200 Volts to about 400 Volts.

Embodiments of an energy storage system can include an energy storage module, where the energy storage module includes a cover providing a space for receiving a plurality of energy storage sub-modules. The cover can include a top cover portion. The energy storage module may include a plurality of energy storage sub-modules adjacent one another received within the space and forming a space between the sub-modules and the top cover portion. A ratio of a total first cross-sectional area A1 to a total second cross-sectional area A2 can be about 1:10 to about 1:40, where A1 can be a combined total of all the cross-sectional areas between the adjacent energy storage sub-modules, each cross-sectional area between two adjacent energy storage sub-modules defined as a separation length L1 between the two adjacent sub-modules multiplied by a length L2 of the two adjacent sub-modules. A2 can be a total cross-sectional area of the space between the plurality of energy storage sub-modules and the top cover portion, where A2 can be defined as a distance L3 from the edges of the sub-modules to an interior surface of the top cover portion multiplied by an interior width of the module L4.

In some embodiments, the energy storage system, can include a carrying tray having a proximal end and a second opposing distal end, a plurality of energy storage devices positioned longitudinally within the carrying tray with respect to one another, an insulator sleeve surrounding the plurality of energy storage devices, and a pair of side plates, a first of the pair of side plates adjacent a first side of the insulator sleeve and a second of the pair of side plates adjacent a second opposing side of the insulator sleeve, where at least one of the pair of side plates can include a plurality of protrusions distributed across an exterior surface.

In some embodiments, the plurality of energy storage devices can have a pouch cell configuration. In some embodiments, the energy storage system, can include a sealing cap over the insulator sleeve and over the proximal end and the second opposing distal end of the carrying tray, where the sealing caps and the insulator sleeve hermetically seal the energy storage devices within a dust-free environment. In some embodiments, the pair of side plates can be fastened to one another to provide a compressive force upon the plurality of energy storage devices.

In some embodiments, the plurality of energy storage devices can include a string of energy storage devices wrapped around the carrying tray, where at least one of the plurality of energy storage devices can be positioned on a first side of the carrying tray and at least one of the plurality of energy storage devices can be positioned on a second opposing side of the carrying tray, a connection portion between the at least one of the plurality of energy storage devices on the first side and second of the carrying tray being wrapped around the second opposing distal end of the carrying tray.

In some embodiments, the energy storage system can include an air flow generator configured to propel air flow from a distal end of the energy storage module to a proximal end of the energy storage module, where the distal end of the energy storage module can be proximate to the second opposing distal end of the carrying tray and the proximal end of the energy storage proximate to the proximal end of the carrying tray.

In some embodiments, the energy storage system can include at least two energy storage devices positioned on each of the first and second side of the carrying tray, where an energy storage device positioned on the carrying tray proximate to the proximal end of the carrying tray can be configured to have an operating temperature no more than about 3° C. greater than an operating temperature of an energy storage device positioned on the carrying tray proximate to the distal end of the carrying tray.

For purposes of summarizing the invention and the advantages achieved over the prior art, certain objects and advantages are described herein. Of course, it is to be understood that not necessarily all such objects or advantages need to be achieved in accordance with any particular embodiment. Thus, for example, those skilled in the art will recognize that the invention may be embodied or carried out in a manner that can achieve or optimize one advantage or a group of advantages without necessarily achieving other objects or advantages.

All of these embodiments are intended to be within the scope of the invention herein disclosed. These and other embodiments will become readily apparent to those skilled in the art from the following detailed description having reference to the attached figures, the invention not being limited to any particular disclosed embodiment(s).

### BRIEF DESCRIPTION OF THE DRAWINGS

These and other features, aspects, and advantages of the present disclosure are described with reference to the drawings of certain embodiments, which are intended to illustrate certain embodiments and not to limit the invention.

FIG. 1 shows an energy storage system installed within a vehicle, according to one embodiment.

FIG. 2A shows a top front perspective view of an example of an energy storage module.

FIG. 2B shows a bottom rear exploded perspective view of the energy storage module of FIG. 2A.

FIG. 3 shows an exploded view of an example of an energy storage sub-module from the energy storage module of FIG. 2A.

FIG. 4 shows a cross-sectional view of an energy storage module, taken along line 4-4 in FIG. 2A.

FIG. 5 shows a side cross-sectional view of an example of an air flow pattern through the energy storage module of FIG. 2A.

FIG. 6A shows a perspective view of a portion of the energy storage sub-module of FIG. 3, according to one embodiment.

FIG. 6B shows an exploded view of the portion of the energy storage sub-module of FIG. 6A.

FIG. 7 shows a heating apparatus and a portion of an energy storage sub-module, according to one embodiment.

### DETAILED DESCRIPTION

Although certain embodiments and examples are described below, those of skill in the art will appreciate that the invention extends beyond the specifically disclosed embodiments and/or uses and obvious modifications and equivalents thereof. Thus, it is intended that the scope of the invention herein disclosed should not be limited by any particular embodiments described below.

In some embodiments, an energy storage system, for example an energy storage system configured to power a motor vehicle, can include an energy storage module having a plurality of energy storage sub-modules positioned adjacent to one another and housed within exterior covers of the energy storage module. The energy storage module may include one or more air flow generators at one end, where the air flow generators can draw air flow into and propel air through the energy storage module to facilitate desired cooling of the energy storage module. In some embodiments, each energy storage sub-module can include a string of a plurality of energy storage devices, each of which can be seated within corresponding receiving recesses of a rectangular or substantially rectangular shaped carrying tray. The string of energy storage devices can be wrapped around the carrying tray such that a first half of the energy storage devices are seated within corresponding receiving recesses on one side of the carrying tray and the second half of the energy storage devices can be seated within corresponding receiving recesses on a second opposing side of the carrying tray. Such a configuration may facilitate a first energy storage device and a last energy storage device of the string being aligned along a same end of the carrying tray, for example facilitating having positive and negative terminals of the string of energy storage devices aligned on the same end. In one embodiment, an insulator sleeve can be placed over and around the plurality of energy storage devices seated within the carrying tray. The insulator sleeve may be configured to apply a compressive force upon the energy storage devices, and/or facilitate hermetic sealing of the plurality of energy storage devices and the carrying tray within a dust particle-free or substantially dust particle-free environment.

In one embodiment, two side plates can be placed over the insulator sleeve-sealed environment such that the two side plates can be fastened together along two corresponding opposing edges to surround the insulator sleeve-sealed environment. The two side plates fastened together can be configured to apply a desired compressive force upon the energy storage devices within the insulator sleeve-sealed environment. One or more of the energy storage devices may comprise a lithium ion capacitor and/or lithium ion battery, where the capacitor and/or the battery have a pouch cell configuration. For example, each of the plurality of energy storage devices may comprise a prismatic pouch cell configuration. Maintaining desired compressive force upon an energy storage device having a pouch cell configuration may facilitate desired operation of the energy storage device, such as by reducing or preventing deformation of the pouch cell due to outward force exerted by gaseous byproducts generated during operation of the pouch cell. In one embodiment, the side plates can comprise a metallic material, including for example, aluminum.

One or more of the side plates can include a plurality of protrusions extending from a surface exterior to the space within which the insulator sleeve-sealed environment is received. For example, the plurality of protrusions can have a configuration and a pattern of distribution across the exterior surface such that the plurality of protrusions can facilitate maintaining a desired separation length between adjacent energy storage sub-modules. Air drawn into and propelled through the energy storage module may contact exterior surfaces of the side plates to facilitate cooling of the energy storage sub-modules. In some embodiments, a separation length maintained between adjacent energy storage sub-modules can be selected to facilitate desired pattern of air flow within the energy storage module such that temperatures of the energy storage devices can be maintained within desired ranges during operation. In some embodiments, a ratio of the separation length to an energy storage sub-module dimension perpendicular in direction to that of the separation length, such as a length of the sub-module, can be about 1:20. An energy storage module having such a ratio may facilitate a pattern of air flow within the module which can provide increased contact of the air with exterior surfaces of the side plates. Of course, other ratios, such as 1:15, 1:18, 1:22, 1:25 or the like are also contemplated. In some embodiments, the separation length is selected such that a ratio of a total cross-sectional area of the space between respective edges of the energy storage sub-modules and the top cover of the energy storage module, and the total cross-sectional area of the spaces between adjacent energy storage sub-modules, is about 10:1 or greater.

As used herein, an energy storage device comprising a “pouch cell” configuration is a term of art which refers to an energy storage device which comprises one or more active components sealed within a flexible housing, such as a flexible pouch. As used herein, the flexible housing of the pouch cell is configured (i.e. sized, shaped, and/or formed from a material) such that it may deform under pressure exerted thereupon by one or more gaseous byproducts generated within the housing during operation of the energy storage device. Deformation of the cell may adversely impact a performance of the pouch cell, for example by contributing to displacement of components of the pouch cell relative to one another.

As used herein, a “prismatic” energy storage device is a term of art which refers to an energy storage device with a plurality of device electrodes in a stacked, generally elongated, and generally flat configuration, and not a “jelly roll” configuration as is known in the art.

In some embodiments, an energy storage device having a prismatic shape may comprise a pouch cell configuration. For example, an energy storage device may comprise a prismatic configuration sealed within a flexible pouch housing. Deformation of the pouch cell comprising the electrodes in a stacked configuration may result in undesired displacement of the electrodes, adversely impacting performance of the cell.

In some embodiments, one or more energy storage modules described herein can have a space-saving configuration while providing desired compression upon and maintaining sufficient cooling of the energy storage devices of the modules. In some embodiments, one or more energy storage modules described herein can have a configuration to facilitate sealing of the energy storage devices within a clean environment. Maintaining a clean operating environment for, desired compression upon and/or sufficient cooling of the energy storage devices may facilitate improved operating life of the energy storage devices.

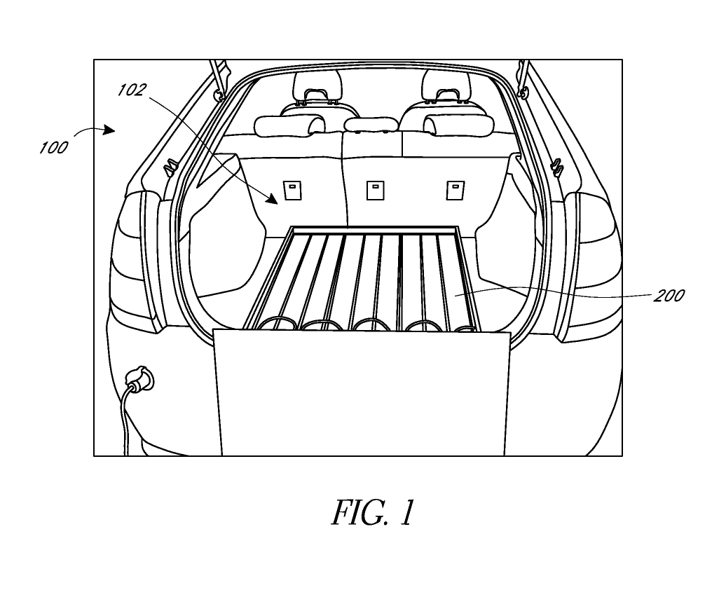

FIG. 1 shows an energy storage system 200 installed within a motor vehicle 100. For example, an energy storage system 200 can be placed in a rear portion 102 of the motor vehicle 100 for powering the motor vehicle 100. Of course, the energy storage system 200 may be placed in other suitable locations within the motor vehicle 100. In some embodiments, one or more energy storage modules can provide the energy storage system 200. For example, the energy storage system 200 may comprise a plurality of energy storage modules coupled in electrical series and/or parallel. Each energy storage module can include one or more sub-modules. Each module and/or submodule can comprise one or more energy storage devices. In some embodiments, the energy storage system 200 can include one energy storage module having a plurality of energy storage devices. An energy storage device may include a capacitor, a battery, a capacitor-battery hybrid, a fuel cell, and/or other energy storage devices, or combinations thereof. For example, the energy storage device may be a lithium ion capacitor. For example, the energy storage device can be a lithium ion battery. In some embodiments, the energy storage device can have a prismatic configuration. The energy storage device can have a pouch cell configuration, such as a lithium ion capacitor and/or a lithium ion battery having a pouch cell configuration.

The energy storage system 200 can be used to power a variety of motor vehicles, including for example, motor vehicles used to transport passengers and/or property or cargo, such as cars, buses, trucks, motorcycles, off-highway vehicles, and/or other vehicles. In some embodiments, the energy storage system 200 can be used to power a sub-system of the motor vehicles. In some embodiments, the energy storage system 200 can be used to power electronic devices, and/or any other electrically powered apparatus, including non-motor vehicle implementations.

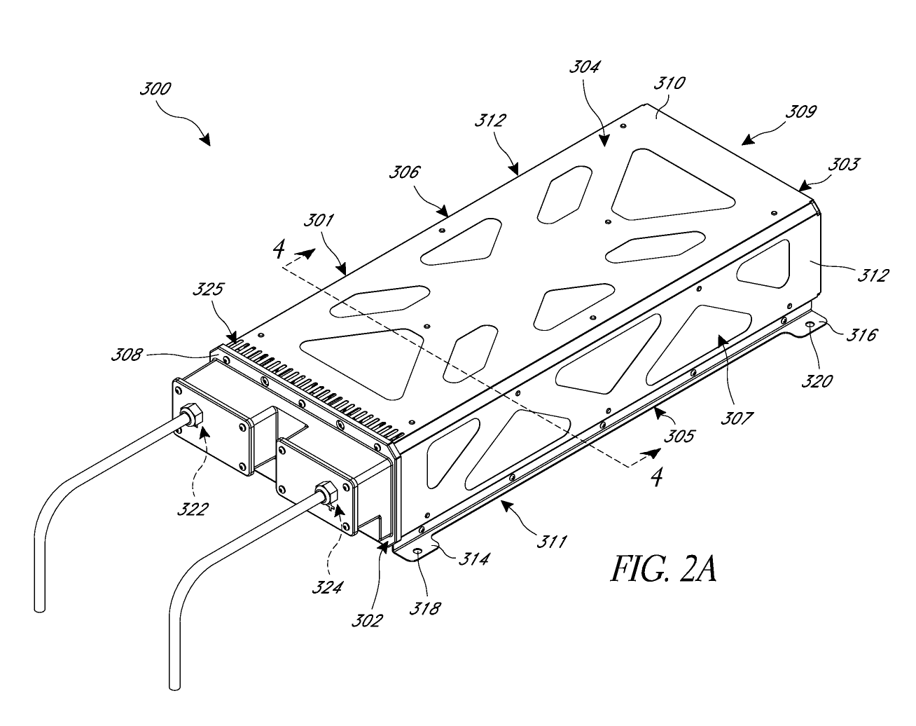

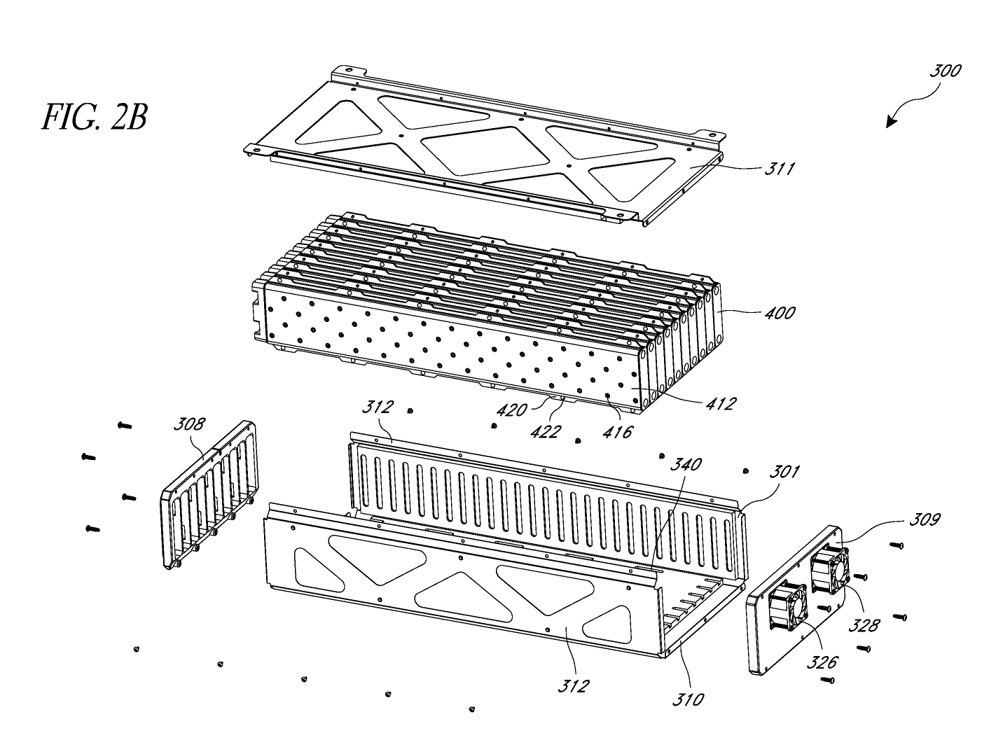

FIG. 2A shows a top front perspective view of an example of an energy storage module 300. For example, the energy storage system 200 of FIG. 1 can include one or more of the energy storage modules 300 coupled in electrical series and/or parallel. The energy storage module 300 can have a prismatic or substantially prismatic shape. As shown in FIG. 2A, the energy storage module 300 can have a rectangular or substantially rectangular elongated prism shape. In some embodiments, other shapes may also be suitable.

In some embodiments, the energy storage module 300 can have a shape and/or one or more design features configured to facilitate stacking of a plurality of energy storage modules 300 such that multiple energy storage modules 300 can be stacked and/or assembled together in a space-saving configuration to provide an energy storage system 200. For example, the plurality of energy storage modules 300 can be electrically coupled in series and/or parallel to power a motor vehicle.

The energy storage module 300 may have a front portion 302, an opposing rear portion 303, a top portion 304 and an opposing bottom portion 305, a left side portion 306, and a right side portion 307. The energy storage module 300 may comprise a cover 301 providing a space within which other components of the energy storage module 300 can be received. For example, the cover 301 may enclose or substantially enclose a prismatic space within which components of the energy storage module 300 can be received. In some embodiments, the cover 301 may comprise a front cover 308, a rear cover 309, a top cover 310, a bottom cover 311, and side covers 312. In some embodiments, one or more of the front cover 308, rear cover 309, top cover 310, bottom cover 311, and side covers 312 may be separate and distinct pieces. As shown in FIG. 2A, the front cover 308, back cover 309, top cover 310, bottom cover 311, and side cover 312 may each be separate and distinct from one another. For example, the front cover 308, back cover 309, top cover 310, bottom cover 311, and side cover 312 may be configured to be coupled to one another via one or more fasteners. In some embodiments, one or more of the front cover 308, back cover 309, top cover 310, bottom cover 311, and side cover 312 may be pre-formed as one contiguous piece. For example, the top cover 310 and side covers 312 may be pre-formed as one contiguous piece.

In some embodiments, the top cover 310 can include a plurality of openings 325 proximate to or at the front end 302 of the module 300. As will be described in further details below, the plurality of openings 325 may be configured to permit air flow therethrough. For example, heated air from within the module 300 may exit through the plurality of openings 325.

In some embodiments, the bottom cover 311 can include one or more mounting elements, such as mounting tabs extending from one or more of its edges, such as one or both of opposing edges extending between the front portion 302 and rear portion 303 of the energy storage module 300. Referring to FIG. 2A, for example, the bottom cover 311 may comprise respective mounting tabs 314, 316 positioned at or proximate to distal portions of an edge extending between the front portion 302 and opposing rear portion 303 of the module 300. In some embodiments, the mounting tabs 314, 316 can be configured to secure the energy storage module 300 relative to another energy storage module 300 and/or relative to an energy storage system of which the energy storage module 300 is a part. For example, the bottom cover portion 311 may comprise mounting tabs 314, 316 on both opposing edges extending between the front portion 302 and opposing rear portion 303 of the module 300. The mounting tabs 314, 316 on both opposing edges may include openings 318, 320, respectively. One or more fasteners may be extended through the openings 318, 320 to facilitate securing of the energy storage module 300 relative to another energy storage module 300 and/or relative to the energy storage system of which the module 300 is a part.

Continuing to refer to FIG. 2A, the front cover 308 can include a first opening 322 to facilitate electrical coupling of the module 300 with an external negatively charged terminal, including a negatively charged circuit. For example, the first opening 322 may permit a negative power cable to extend therethrough for coupling with an external terminal. The front cover 308 can also include a second opening 324 configured to facilitate electrical coupling of the module 300 with an external positively charged terminal, including a positively charged circuit. For example, the second opening 324 may permit a positive power cable to extend therethrough. FIG. 2A shows each of the first opening 322 and the second opening 324 on the front cover 308 positioned near a top edge at a location offset from a center of the front cover 308. For example, the first opening 322 and the second opening 324 may be positioned at equal or substantially equal distances from respective ends of the top edge. It will be understood that the positioning of the first and second openings 322, 324 as shown is for illustrative purposes and the first and second openings 322, 324 can be placed at other suitable positions on the front cover 308. For example, positioning of the first and second openings 322, 324 may be selected to facilitate assembling multiple energy storage modules 300 into a space-saving configuration, such as to provide a compact energy storage system 200.

FIG. 2B shows a bottom, rear exploded view of the energy storage module 300 shown in FIG. 2A, comprising one or more energy storage sub-modules 400. FIG. 2B shows the energy storage module 300 in a different orientation than that shown in FIG. 2A such that additional details can be visible. For example, the covers 308, 309, 310, 311, and 312 of the energy storage module 300 can be assembled to house a plurality of energy storage sub-modules 400.

Air can be flowed through the energy storage module 300 to control the temperature within the energy storage module 300. In some embodiments, air can be flowed into the module 300 such that the air can be propelled from one end, such as the rear end 303 of the module 300, and flowed across the energy storage submodules 400 to an opposing end, such as the front end 302 of the module 300. In some embodiments, air can be propelled from one end, such as the rear end 303 or the front end 302 and flowed through the module 300 such that air heated by the sub-modules 400 exits through the same end.

The air flow through the energy storage module 300 can be provided in different ways that provide a pressure drop within module 300 across the sub-modules 400, such as through passive air flow, or through active devices, such as an air flow generator. In some embodiments, desired air flow through the energy storage module 300 can be provided passively by providing a pressure drop across the submodules 400 and the module 300. In some embodiments, desired air flow can be provided passively, for example, as the module 300 is moved at sufficient velocities to force air through module 300 and between its sub-modules 400. For example, air flow can be provided through the module 300 as a result of stagnation pressure, such as by being mounted on a moving motor vehicle. Thus, the air flow through the module 300, resulting in air flow across, and temperature transfer from, the sub-modules 400 can be provided through any active or passive means which provide a pressure drop across portions of the module 300 and/or the sub-modules 400 within module 300.

In some embodiments, the air flow can be provided actively. In some embodiments, air flow can be provided by one or more air flow generators. In some embodiments, the energy storage module 300 can be a part of an energy storage system, such as the energy storage system 200, and the energy storage system 200 may include the one or more air flow generators for providing desired air flow through the module 300. In some embodiments, one or more air flow generators can be provided as part of the motor vehicle or other electrically powered apparatus for which the module 300 provides electrical power. In some embodiments, the energy storage module 300 can include one or more air flow generators. In some embodiments, one or more of the energy storage system, the electrically powered apparatus, and the energy storage module 300 can include the one or more air flow generators.

In some embodiments, the energy storage module 300 can include one or more air flow generators positioned at suitable locations to provide airflow through a portion of cover 301, and across one or more of the sub-modules 400 within cover 301, to control the temperature within the energy storage module 300. The one or more air flow generators may be at the rear end 303 of the module. As shown in FIG. 2B, in some embodiments, a first air flow generator 326 and a second air flow generator 328 may be at the rear end of the module 300. For example, the back cover 309 of the energy storage module 300 can be configured to be coupled to the one or more air flow generators, such as the first air flow generator 326 and the second air flow generator 328.

In some embodiments, the one or more air flow generators can be positioned and configured in different ways to provide desired air flow through the energy storage module 300. For example, positioning and configuration of the air flow generators 326, 328 may be selected to facilitate even or substantially even distribution of the air flow through the energy storage module 300. The air flow generators 326, 328 can be configured and positioned in a way suitable to facilitate formation of an airflow boundary layer within the energy storage module 300. For example, the air flow generators 326, 328 can be configured and positioned suitably to allow air flow across at least at portion of at least one of sub-modules 400, such as an exterior surface thereof. In some embodiments, the one or more air flow generators can be coupled to the back cover 309 at a position offset from a center of the back cover 309, for example to facilitate drawing of air into the energy storage module 300 along a bottom portion of the energy storage module 300. The first air flow generator 326 and the second air flow generator 328 can be evenly spaced apart along a line on the back cover. The first air flow generator 326 and the second air flow generator 328 may be placed near a bottom edge and offset from a center on the back cover 309. For example, as will be described herein in further details, the first air flow generator 326 and the second air flow generator 328 may be placed at a position on the back cover 309 configured to facilitate generation of an air flow pattern through the energy storage module 300. The air flow pattern that is implemented can increase contact, and thus increase temperature transfer, between the air and portions of the energy storage sub-modules 400. For example, such temperature transfer can be increased between the air and exposed or exterior portions of the sub-modules 400 within the interior of cover 301 of module 300. In some embodiments, increased contact between the air flow and exterior surfaces of the energy storage sub-modules 400 can facilitate improved heat removal from the energy storage sub-modules 400 during operation of energy storage devices housed within the energy storage sub-modules 400. In some embodiments, placement of the one or more air flow generators 326, 328 at one end, such as at the back end 303, of the energy storage module 300 may facilitate fabrication of a compact energy storage module 300 suitable to provide electrical power for various applications, including for example space-constrained applications.

Suitable air flow generators can include any number of devices capable of generating a desired air flow current through the energy storage module 300, including for example any number of electric fans, pumps, or other suitable air flow devices configured to draw air external to the module 300 into and propel the air through the module 300 to facilitate effective cooling of the module 300. The one or more air flow generators can be configured to facilitate maintenance of the energy storage module 300 and/or energy storage sub-module 400 at temperatures suitable for proper operation. In some embodiments, one or more air flow generators can be configured to provide sufficient air flow to facilitate maintaining one or more energy storage devices of the energy storage sub-module 400 at a temperature of up to about 55° C. during operation of the one or more energy storage devices, for example maintaining a temperature of the energy storage devices between ambient temperature (e.g., about 20° C. to about 25° C.) and about 55° C. One or more air flow generators can be configured to provide sufficient air flow to facilitate maintaining each energy storage device of the energy storage sub-module 400 at a temperature of up to about 55° C. during operation of the energy storage devices.

In some embodiments, one or more air flow generators coupled to a back cover 304 can be configured to provide sufficient air flow to maintain a desired temperature difference between a temperature of an energy storage device 402 proximate to an end of the energy storage sub-module 400 adjacent to the air flow generators, and a temperature of an energy storage device 402 proximate to a second opposing end of the energy storage sub-module 400. In some embodiments, maintaining the desired temperature difference between energy storage devices 402 proximate to opposite ends of the sub-module 400 may facilitate providing energy storage devices 402 having desired rate of aging, for example such that the energy storage devices 402 demonstrate desired length of useful life. For example, a lithium ion capacitor may be deemed as reaching end of life once its capacitance decreases to about 80% of its initial capacitance. Maintaining the desired temperature difference may facilitate providing an energy storage sub-module 400 comprising energy storage devices 402 each demonstrating a desired duration of useful life, such as demonstrating a capacitance of greater than or equal to about 80% for a desired duration.

In some embodiments, one or more air flow generators coupled to a back cover 309 of the module 300 can be configured to provide sufficient air flow to facilitate maintaining an operating temperature difference of no more than about 10° C. between a temperature of an energy storage device 402 proximate to an end of the energy storage sub-module 400 adjacent to the air flow generators, and a temperature of an energy storage device 402 proximate to a second opposing end of the energy storage sub-module 400. In some embodiments, the one or more air flow generators coupled to a back cover 309 of the module 300 can be configured to provide sufficient air flow to facilitate maintaining a temperature difference of no more than about 5° C., about 4° C., about 3° C., or about 2° C.

In some embodiments, one or more air flow generators coupled to a back cover 309 can be configured to draw an amount of air into and propel the amount of air through the energy storage module 300 to facilitate maintaining a temperature of a space interior of the storage module 300 and exterior of the energy storage sub-module 400 at about 40° C. or less, for example between ambient temperature (e.g., about 20° C. to about 25° C.) and about 40° C. It will be understood that the aforementioned performance characteristics of embodiments of the energy storage module and sub-modules can be achieved through the described various configurations and positioning of the air-flow generators, alone, or in combination with the configuration and positioning of other features of the energy storage module and sub-modules, such as the separation length between sub-modules, or other features described elsewhere herein.

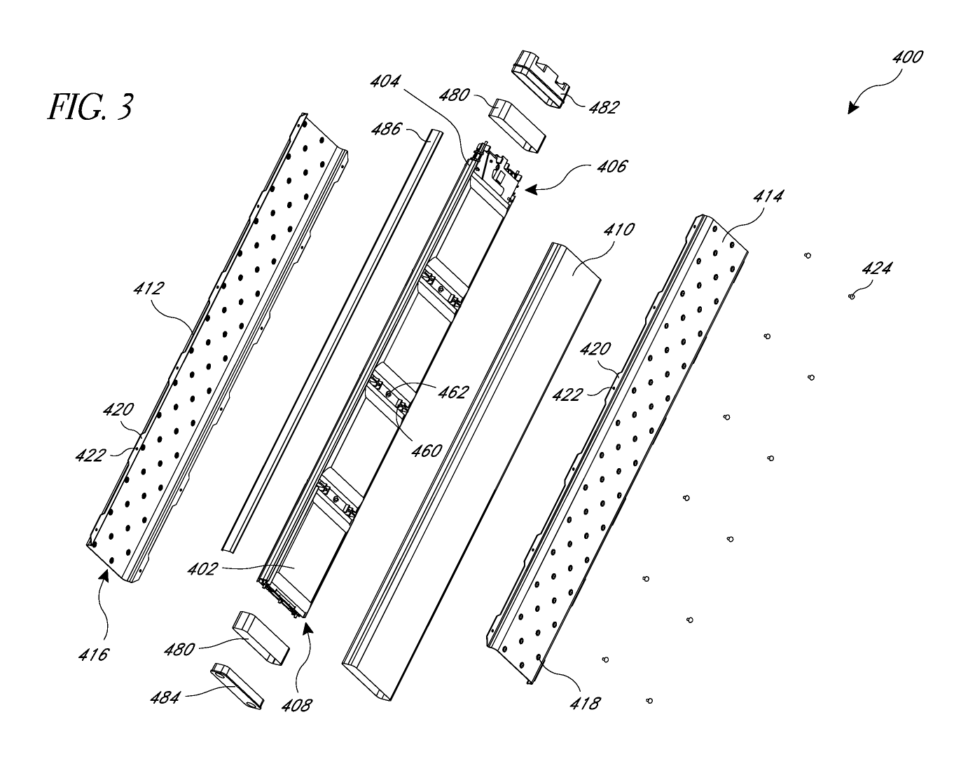

FIG. 3 shows a partially exploded view of the energy storage sub-module 400. The energy storage sub-module 400 can include a first side plate 412 and a second side plate 414. Each of the side plates 412, 414 can have one or more alignment elements, such as six alignment tabs 420 extending from and distributed at regular intervals along each of two opposing edges. Of course, a different number of alignment tabs may also be suitable, such as two, three, or four alignment tabs extending from each of the two opposing edges. In some embodiments, the alignment tabs may not be evenly distributed along an edge of a side plate. In some embodiments, each alignment tab 420 can have an opening 422. Each alignment tab 420 on the first side plate 412 may be fastened to a corresponding alignment tab 420 on the second side plate 414 using respective openings 422 on the alignment tabs 420, as will be described in further detail herein.

As shown in FIG. 2B, the top cover 310 of the energy storage module 300 can include a plurality of recesses 340 on a surface facing an interior of the energy storage module 300. In some embodiments, the bottom cover 311 of the energy storage module 300 can include a corresponding plurality of recesses (not shown in FIG. 2B) similar to recesses 340, but on a surface of the bottom cover 311 facing an interior of the energy storage module 300. Each of the plurality of recesses on the top cover 310 and bottom cover 311 can be configured and positioned to receive a pair of corresponding alignment elements, such as alignment tabs 420 (one for each of plates 412, 414; FIG. 3), of an energy storage sub-module 400. Each pair of alignment tabs 420 which are fastened together can be inserted into corresponding recesses 340 on the top cover 310 or bottom cover 311 of the energy storage module 300. The plurality of recesses and the corresponding tabs can be collinear when sub-module 400 is attached to the top cover 310 and the bottom cover 311. For example, the top cover 310 and/or bottom cover 311 may include a plurality of three or more recesses 340 distributed along a line extending between a front end 302 and rear end 303 of the module, with the line corresponding to attachment with one sub-module 400. Additional sets of three or more recesses 340 can be distributed along additional lines (e.g., parallel lines), although this is not shown in the view of FIG. 3. The mating of a pair of alignment tabs 420 of an energy storage sub-module 400 with the recesses on an energy storage module top cover 310 or bottom cover 311 may facilitate secure positioning and/or alignment of the plurality of energy storage sub-modules 400 within the energy storage module 300. Secure positioning of the sub-modules can reduce vibration between these components, increasing reliability. Secure alignment between these components can improve the reliability of the spacing between sub-modules, which can improve control of the air flow across the sub-modules, and thus improve overall temperature control of the module. It will be understood that the top cover and bottom cover

The energy storage module 300 can include different quantities of sub-modules, such as the ten energy storage sub-modules 400 shown in FIG. 2B. Individual energy storage sub-modules 400 can be aligned and positioned adjacent to one another. For example, the number of energy storage sub-modules 400 can be coupled in electrical parallel and implemented in a given quantity within storage module 300 to provide a desired energy output.

In some embodiments, the energy storage module 300 may include a different number of energy storage sub-modules 400, based upon a desired energy storage module operating voltage. For example, more or fewer energy storage sub-modules 400 can be included in an energy storage module 300 depending on whether a higher or lower operating voltage is desired, respectively. In some embodiments, a plurality of energy storage sub-modules 400 can be coupled in electrical series.

Referring to FIG. 3, the sub-module 400 can include a carrying tray 404. The sub-module 400 can include the plurality of energy storage devices 402 positioned on the carrying tray 404. The carrying tray 404 can have a rectangular or substantially rectangular shape. For example, the carrying tray 404 may have a first end 406 and an opposing second end 408, and two parallel or substantially parallel edges extending between the first end 406 and the opposing second end 408. For example, the first end 406 may be proximate to a front cover 308 of the energy storage module 300 and the second end 408 may be proximate to the back cover 309 of the energy storage module 300, when the energy storage sub-module 400 is positioned within the module 300.

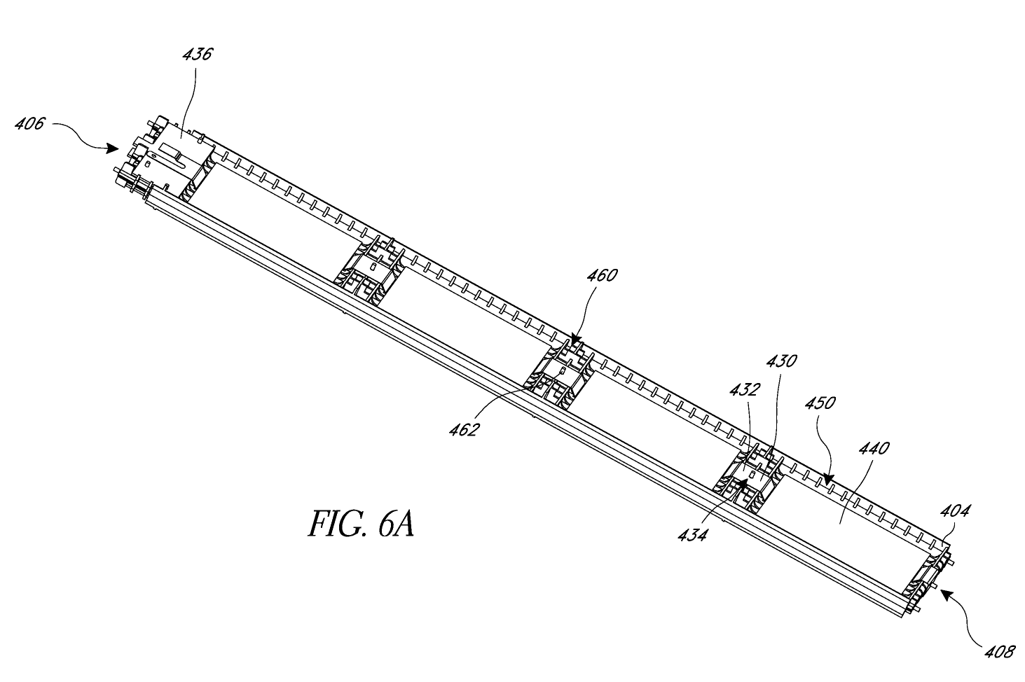

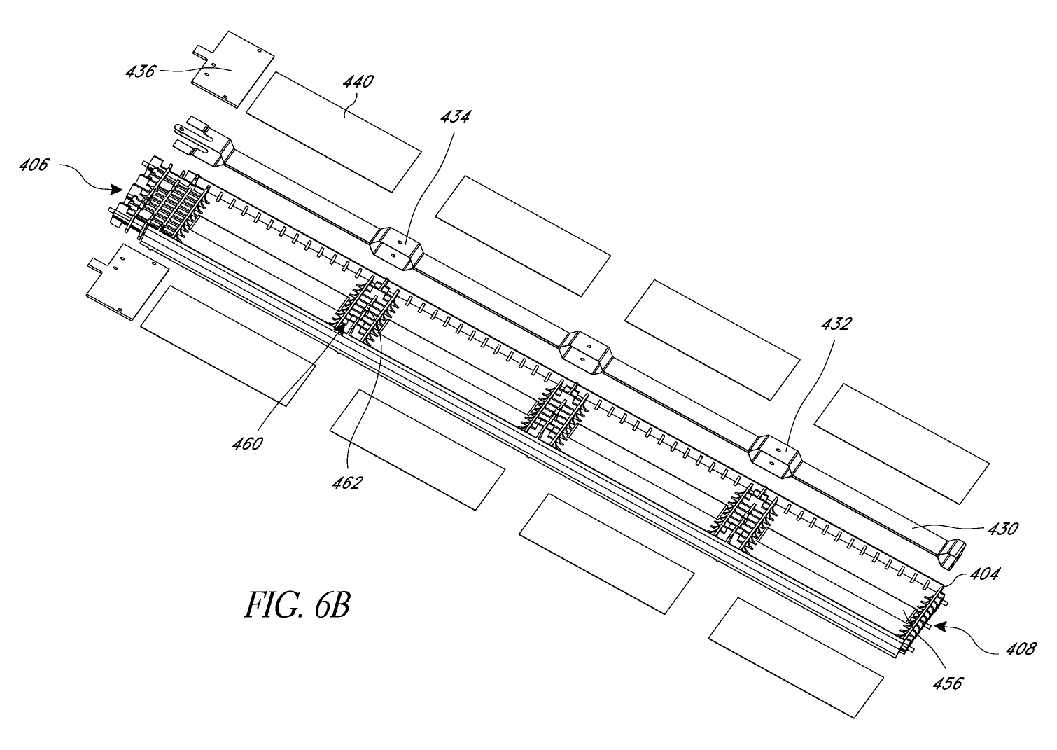

The carrying tray 404 may have a plurality of receiving recesses 450 (e.g., as shown in FIG. 6A), each of which having a shape and/or size configured to receive a corresponding energy storage device 402. As shown in FIG. 3, the energy storage device 402 may comprise a prismatic or substantially prismatic shape. In some embodiments, the sub-module 400 can include four energy storage devices 402 positioned on a first side of the carrying tray 404. Each of the plurality of energy storage devices 402 can be seated into a respective receiving recess 450 on the first side of the carrying tray 404. In some embodiments, an additional four energy storage devices 402 can be seated within respective receiving recesses 450 on a second side opposite that of the first side of the carrying tray 404, such that a sub-module 400 can include eight energy storage devices 402 seated on the carrying tray 404. In some embodiments, the eight energy storage devices 402 may be connected end to end. For example, a second end of a first energy storage device 402 may be connected to a first end of a second energy storage device 402, and a second opposing end of the second energy storage device 402 can be connected to a first end of a third energy storage device 402, and so on, forming a string of eight energy storage devices. The string of eight energy storage devices can be wrapped around the carrying tray 404. For example, a set of four of the energy storage devices 402 can be seated on each of a first and second side of the carrying tray 404, such that the connection portion between the fourth and fifth energy storage devices 402 is wrapped around the second end 408 of the carrying tray 404. For example, the first and last energy storage devices 402 in the string of energy storage devices may be aligned or substantially aligned along the first end 406 of the carrying tray 404. In one embodiment, such a configuration can facilitate alignment of negative and positive terminals of the string of energy storage devices along one edge of the carrying tray 404, such as the first end 406 of the carrying tray 404. Allowing electrical coupling of both positive and negative terminals along a same end may provide an energy storage module 300 having a space-saving configuration.

In some embodiments, the sub-module 400 can include a cell balancing device 430 (e.g., as shown in FIG. 6A) coupled to each of the energy storage devices 402. In some embodiments, the carrying tray 404 can be configured to facilitate securing of the energy storage devices 402 and/or the cell balancing device 430 at desired positions within the sub-module 400. As shown in FIG. 3, the carrying tray 404 may include a raised portion 460 between adjacent receiving recesses 450, separating the adjacent receiving recesses 450. In some embodiments, the raised portion 460 between adjacent receiving recesses 450 may include a protrusion 462 configured to facilitate coupling of the energy storage devices 402 seated within the respective receiving recesses 450 to the cell balance device 430, as will be described in further detail herein.

In some embodiments, the carrying tray 404 may comprise a polymeric material. For example, the carrying tray 404 can be made of a polymeric material which can demonstrate chemical and/or mechanical stability during operation of the energy storage devices 402 seated in the carrying tray 404. In some embodiments, the polymeric material can be chemically resistant or substantially chemically resistant to an electrolyte of the energy storage devices 402. In some embodiments, the polymeric material of the carrying tray 404 can maintain structural integrity across operation temperatures of the energy storage devices 402. In some embodiments, the polymeric material of the carrying tray 404 can demonstrate desired flammability ratings. For example, the carrying tray 404 can comprise or consist essentially of polypropylene. The carrying tray 404 made of a polypropylene material may advantageously be cost effective, provide desired chemical and/or mechanical stability and/or flammability characteristics.

In some embodiments, the carrying tray 404 can be configured to be lightweight while providing desired structural strength to maintain a desired position for one or more other components of the energy storage sub-module 400. In some embodiments, the carrying tray 404 can be configured to comprise a reduced quantity of material such that the carrying tray can be lighter in weight. In some embodiments, the carrying tray 404 may be configured to be fabricated using a reduced amount of material such that the carrying tray 404 can be flexible, for example increased structural rigidity of the energy storage sub-module 400 being provided by another component of the energy storage sub-module 400. For example, an amount of material used in fabricating the carrying tray 404 may be reduced, and/or the carrying tray 404 can be one or more design features, such that the carrying tray 404 can be lightweight, while having sufficient material to provide desired structural rigidity to facilitate positioning of other components of the energy storage sub-module 400, such as positioning of the energy storage devices 402 and balancing device 430 at desired positions relative to one another. The carrying tray 404 may have a reduced thickness while providing desired structural rigidity. In some embodiments, the carrying tray 404 can include one or more ribs along one or more edges of a receiving recess 450 to facilitate secure seating of the energy storage device 402 within the receiving recess 450.

In some embodiments, the energy storage sub-module 400 can include one or more adhesive strips 486 configured to facilitate securely seating the energy storage devices 402 in the carrying tray 404. For example, the adhesive strip 486 may be applied along at least a portion of an edge of the carrying tray 404, such as along at least a portion of an edge extending between the first end 406 and the opposing second end 408 of the carrying tray 404. In some embodiments, the adhesive strip 486 may be in contact with each of the energy storage devices 402 seated in the carrying tray. In some embodiments, the energy storage sub-module 400 can include two adhesive strips 486. For example, one adhesive strip 486 applied along an entire or substantially entire length of each of the two opposing longitudinal edges extending between the first end 406 and the opposing second end 408 of the carrying tray 404 such that each adhesive strip 486 can be in contact with each of the energy storage devices 402. As shown in FIG. 3, an adhesive strip 486 can have a rectangular or substantially rectangular shape. Other shapes may also be suitable. The adhesive strip 486 can be made of a number of suitable materials, including for example, a polymeric material having one or more adhesive surfaces, such as a polyimide film having a silicone adhesive. For example, the adhesive strip 486 may comprise a polyimide strip having silicone adhesive along an entire or substantially an entire surface to facilitate adhesion of the adhesive strip 486 to the carrying tray 404 and the energy storage devices 402.

In some embodiments, the energy storage sub-module 400 can include an insulator sleeve 410 configured to be placed over and around the energy storage devices 402 when seated onto the carrying tray 404. The insulator sleeve 410 can have a shape and/or size configured to fit around the energy storage devices 402 and the carrying tray 404 with desired tension. For example, the insulator sleeve 410 may facilitate secure seating of the energy storage devices 402 on the carrying tray 404, and/or sealing of the energy storage devices 402 in an environment having reduced, or without or substantially without dust particles. The insulator sleeve 410 may comprise a number of electrically insulating materials, including various insulating polymeric materials. For example, the insulator sleeve 410 can be made of a polymeric material which can demonstrate chemical and/or mechanical stability across operation temperatures of the energy storage devices 402. In some embodiments, the polymeric material of the carrying tray 404 can demonstrate desired flammability ratings. In some embodiments, the insulator sleeve 410 can comprise polypropylene, polytetrafluoroethylene, polyester, combinations therefore, and/or the like. For example, the insulator sleeve 410 can comprise or consist essentially of polypropylene.

As shown in FIG. 3, the energy storage sub-module 400 may include two sealing caps 480, where a sealing cap 480 can be coupled to each of two opposing ends of the insulator sleeve 410. For example, a sealing cap 480 can be coupled to an end of the insulator sleeve 410 adjacent to the first end 406 of the carrying tray 404 and a sealing cap 480 can be coupled to a second opposing end of the insulator sleeve 410 adjacent the second end 408 of the carrying tray 404. A sealing cap 480 may comprise an adhesive material configured to facilitate sealing of the energy storage devices 402 seated in the carrying tray 404 within the insulator sleeve 410. In some embodiments, a hermetic seal of the energy storage devices 402 can be formed using the insulator sleeve 410 and the two sealing caps 480. The sealing caps 480 can comprise a number of suitable materials, including for example, a polymeric material having one or more adhesive surfaces for coupling to the insulator sleeve 410, such as a polyimide material and a silicone adhesive on one or more surfaces of the polyimide material to facilitate adhesion to the insulator sleeve 410.

In some embodiments, the insulator sleeve 410 can provide a desired compressive force upon the energy storage devices 402. As described herein, one or more of the plurality of energy storage devices 402 can comprise a pouch cell configuration, such as a prismatic pouch cell configuration. For example, each of the plurality of energy storage devices 402 can be a lithium ion capacitor having a prismatic pouch cell configuration. A pouch cell may deform under pressure exerted by gaseous byproducts generated during operation of the cell. In some embodiments, application of a compressive force upon at least a portion of the pouch cell housing can reduce such deformation of the cell. Reduction in deformation of the cell may improve operation of the device, for example by maintaining components of the cell in desired positions within the housing.

In some embodiments, the energy storage sub-module 400 can include two end caps, such as a first end cap 482 and a second end cap 484. The first end cap 482 can be configured to be placed over the insulator sleeve 410 and the sealing cap 480 adjacent a first end 406 of the carrying tray, and the second end cap 484 can be configured to be placed over the insulator sleeve 410 and the sealing cap 480 adjacent a second end 408 of the carrying tray. In some embodiments, the end caps 482, 484 can be configured to facilitate sealing of the energy storage devices 402 in a clean environment and/or securely seating the energy storage devices 402 in the carrying tray 404. The end caps 482, 484 may be made of a number of suitable materials, including for example, a number of polymeric materials. In some embodiments, one or more of the first end cap 482 and second end cap 484 can comprise polypropylene, polytetrafluoroethylene, polyester, combinations therefore, and/or the like.

Continuing to refer to FIG. 3, the first side plate 412 may be positioned adjacent to the insulator sleeve 410 and the second side plate 414 may be placed adjacent to a second opposing side of the insulator sleeve 410. For example, the first side plate 412 and the second side plate 414 may be in contact with the insulator sleeve 410. In some embodiments, the first side plate 412 and the second side plate 414 may cover or substantially cover the insulator sleeve 410. Thus, the first side plate 412 and the second side plate 414 may be adjacent to, and cover or substantially cover the sealed energy storage devices 402 seated in the carrying tray 404 within the insulator sleeve 410. In some embodiments, the side plates 412, 414 can be placed over at least a portion of the adhesive strip 486, the sealing caps 480, and the end caps 482, 484. In some embodiments, the side plates 412, 414 can be placed over and cover or substantially cover the adhesive strips 486, the sealing caps 480, and the end caps 482, 484. In some embodiments, the side plates 412, 414 cover only a portion of the first end cap 482.

In some embodiments, the side plates described herein can include a plurality of protrusions distributed across a surface of the plate. For example, as shown in FIG. 3, each of the first side plate 412 and second side plate 414 can include a plurality of protrusions 416, 418, respectively, configured to protrude outwardly from exterior surfaces on the side plates 412, 414. The protrusions 416, 418 may protrude outwardly from respective exterior surfaces of the side plates 412, 414 not facing the energy storage devices 402 when the side plates 412, 414 are placed adjacent to the energy storage devices 402. In some embodiments, the plurality of protrusions can facilitate separation between adjacent sub-modules when individual sub-modules are placed in an energy storage module. For example, the protrusions can have a shape and/or size configured to provide a desired separation distance between adjacent energy storage sub-modules. In some embodiments, the plurality of protrusions can be distributed across an exterior surface of the side plate such that a pressure applied upon the side plate can be evenly distributed across the side plate. For example, the plurality of protrusions can be evenly distributed across the exterior surface of the side plate.

In some embodiments, only one of two side plates of an energy storage sub-module includes a plurality of protrusions extending from an exterior surface. In some embodiments, only one of two adjacent side plates from two adjacent energy storage sub-modules in an energy storage module includes a plurality of protrusions. For example, the plurality of protrusions on the one side plate of two adjacent side plates can have a size and/or shape configured to provide the desired separation distance between adjacent energy storage sub-modules.

As described herein, the first side plate 412 and the second side plate 414 can each include a plurality of alignment tabs 420 distributed along opposing edges of the side plates 412, 414. The alignment tabs 420 may be configured to facilitate fastening of the first side plate 412 to the second side plate 414. For example, a plurality of alignment tabs 420 can be distributed at regular intervals along each of two opposing edges of the side plates 412, 414. In one embodiment, as shown in FIG. 3, each side plate can have six alignment tabs 420 distributed at regular intervals along each of opposing edges of the respective side plate. Each of the alignment tabs 420 can include an opening 422 configured to facilitate a fastener 424 to be extended therethrough. Corresponding alignment tabs 420 of the first side plate 412 and the second side plate 414 can be aligned such that a fastener 424 can be placed through the respective openings 422 on the corresponding alignment tabs 420 to fasten together the first side plate 412 and the second side plate 414. As described herein, each pair of fastened alignment tabs 420 may be inserted within corresponding recesses on the interior surface of the top cover 310 or on the interior surface of the bottom cover 311 of the energy storage module 300 to facilitate securely positioning the energy sub-module 400 at a desired location within the energy storage module 300.

In some embodiments, the first side plate 412 and the second side plate 414 can be fastened together such that the energy storage devices 402 can be sandwiched between the plates, 412, 414. In some embodiments, a side plate may comprise a material configured to provide structural support for the energy storage devices 402. In some embodiments, the first side plate 412 and the second side plate 414 can be fastened together to provide compressive force upon the energy storage devices 402. As described herein, one or more of the energy storage devices 402 may comprise a pouch cell configuration, such as a prismatic pouch cell configuration. The pouch cell may deform under pressure exerted by gaseous byproducts generated during operation of the cell. In some embodiments, a side plate can comprise a material having desired structural rigidity such that desired compressive force can be applied upon the energy storage devices 402 between the side plates 412, 414 to reduce or prevent deformation of the energy storage devices 402. The side plates 412, 414 may be configured to provide desired resistance to deformation when force is exerted thereupon by the energy storage devices 402 placed between the side plates.

In some embodiments, the side plates 412, 414 may comprise a material to provide sufficient temperature (e.g., heat) transfer with respect to the energy storage devices 402. For example, the side plates 412, 414 may comprise a material having sufficient thermal conductivity to facilitate heat removal from the energy storage sub-module 400.

In some embodiments, the side plates described herein can comprise a metallic material, including for example, aluminum, copper, stainless steel, alloys thereof, and/or the like. For example, one or both of the first side plate 412 and the second side plate 414 may comprise aluminum. For example, one or both of the first side plate 412 and the second side plate 414 may consist essentially of aluminum. In some embodiments, the plurality of protrusions on the side plates can be created on a metallic side plate using a stamping technique. For example, the first side plate 412 and the second side plate 414 may be aluminum side plates, and the plurality of protrusions on the first side plate 412 and the second side plate 414 may be formed by stamping the aluminum side plates 412, 414.

In some embodiments, the energy storage device 402 can comprise a lithium ion capacitor. For example, the energy storage device 402 may comprise a lithium ion capacitor having a pouch cell configuration. In one embodiment, a pouch cell lithium ion capacitor can have an operating voltage of about 3.8 Volts (V). As described herein, an energy storage sub-module 400 can include eight energy storage devices 402 coupled in electrical series. For example, an energy storage sub-module 400 including eight lithium ion capacitors, each with an operating voltage of about 3.8 V, coupled in electrical series such that the energy storage sub-module 400 can be configured to provide an operating voltage of about 30 V. In some embodiments, an energy storage module 300 can include ten energy storage sub-modules 400 connected in electrical series. For example, an energy storage module 300 having ten energy storage sub-modules 400 connected in electrical series can provide an operating voltage of about 300 V, where each energy storage sub-module 400 includes eight pouch cell lithium ion capacitors coupled in electrical series and configured to provide an operating voltage of about 3.8 V each. In some embodiments, an energy storage module 300 may comprise a number of storage sub-modules 400 connected in electrical series to provide an operating voltage of about 200 V to about 400 V.

In some embodiments, an energy storage sub-module 400 can include four energy storage devices 402 coupled in electrical series. For example, an energy storage sub-module 400 including four lithium ion capacitors, each capacitor with an operating voltage of about 3.8 V, coupled in electrical series, such that the energy storage sub-module 400 can be configured to provide an operating voltage of about 15 V. In some embodiments, an energy storage module 300 can include four energy storage sub-modules 400 connected in electrical series. For example, an energy storage module 300 having four energy storage sub-modules 400 connected in electrical series can provide an operating voltage of about 60 V, where each energy storage sub-module 400 includes four pouch cell lithium ion capacitors coupled in electrical series and configured to provide an operating voltage of about 3.8 V each.

In some embodiments, an energy storage module 300 can provide a different operating voltage. For example, the energy storage module 300 may include a different number of energy storage sub-modules 400. In some embodiments, an energy storage sub-module 400 can include other than eight or four energy storage devices 402. The number of energy storage sub-modules 400 can be scaled based on a desired energy performance of the energy storage module 300. The number of energy storage devices 402 can be scaled based on a desired energy performance of the energy storage sub-module.

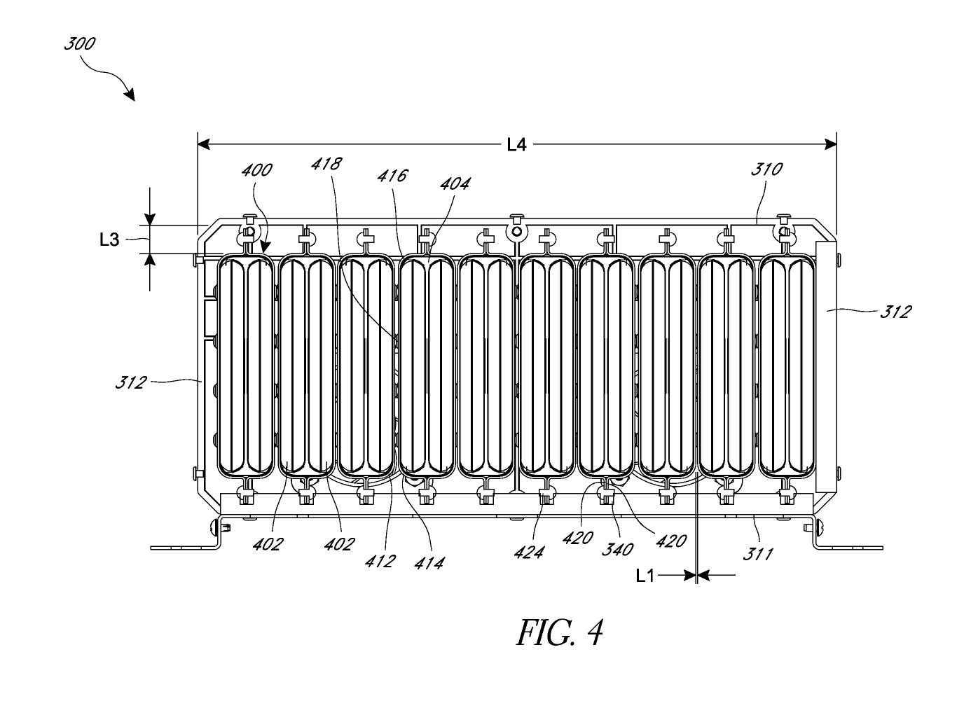

FIG. 4 shows a cross-sectional view of the energy storage module 300, taken along line 4-4 in FIG. 2A. As shown, energy storage devices 402 are seated on either of two opposing sides of the carrying tray 404 for each energy storage sub-module 400. FIG. 4 also shows how corresponding alignment tabs 420 of side plates 412, 414 for each energy storage sub-module 400 can be fastened together using fasteners 424. Each pair of alignment tabs 420, once fastened together, may be inserted into corresponding recesses 340 on the bottom cover 311 of the energy storage module 300.

Each side plate 412, 414 can include a respective plurality of protrusions 416, 418. As described herein, the plurality of protrusions 416, 418 can provide a desired separation distance between the adjacent energy storage sub-modules 400. A distribution of the plurality of protrusions across a surface of a side plate, and/or a shape and/or size of the plurality of protrusions on a side plate, can be selected to facilitate a desired separation distance between adjacent energy storage sub-modules 400. In some embodiments, the plurality of protrusions on a side plate can have a same configuration (e.g., a same height, and/or shape), with respect to each protrusion, or with respect to a second plurality of protrusions on an adjacent side plate. In some embodiments, a plurality of protrusions of a side plate can be off-set from a plurality of protrusions on an adjacent side plate. For example, a separation distance between adjacent energy storage sub-modules 400 can be determined by a height of one or more protrusions on one of the two adjacent side plates. For example, the plurality of protrusions on one side plate can be in direct contact with a flat or substantially flat surface of an adjacent side plate of an adjacent sub-module 400.

In some embodiments, the separation distance between adjacent side plates 412, 414 of respective adjacent sub-modules 400 can be selected to facilitate desired distribution of air flow through the energy storage module 300 such that sufficient cooling can be achieved while maintaining a compact module 300. The separation distance is shown as length L1 in FIG. 4. In some embodiments, the separation distance (L1) can be selected such that total, combined air flow between all the adjacent energy storage sub-modules 400 is equal to or substantially equal to air flow between respective upper edges of the energy storage sub-modules 400 and the top cover 310. In some embodiments, the separation distance (L1) is selected such that a ratio of a total cross-sectional area of the spaces between adjacent energy storage sub-modules 400 (abbreviated herein as A1 and explained further below) and a total cross-sectional area of the space between the respective upper edges of the energy storage sub-modules 400 and the top cover 310 (abbreviated herein as A2, and explained further below), is about 1:10 or greater. In some embodiments, such a ratio of A1:A2 can be about 1:10 to about 1:40, about 1:10 to about 1:30, about 1:10 to about 1:20. In some embodiments, the ratio can be about 1:10. In some embodiments, an energy storage module 300 having such ratios of A1:A2 can provide uniform distribution of air flow through the module 300 and/or facilitate formation of boundary layer in the air flow through the energy module 300, such that desired energy storage sub-module operating temperatures can be achieved (e.g., desired operating temperatures and/or differences in operating temperatures of energy storage sub-modules, as described herein). These ratios can allow air flow through the module 400 to provide desired cooling while maintaining a space-saving configuration.

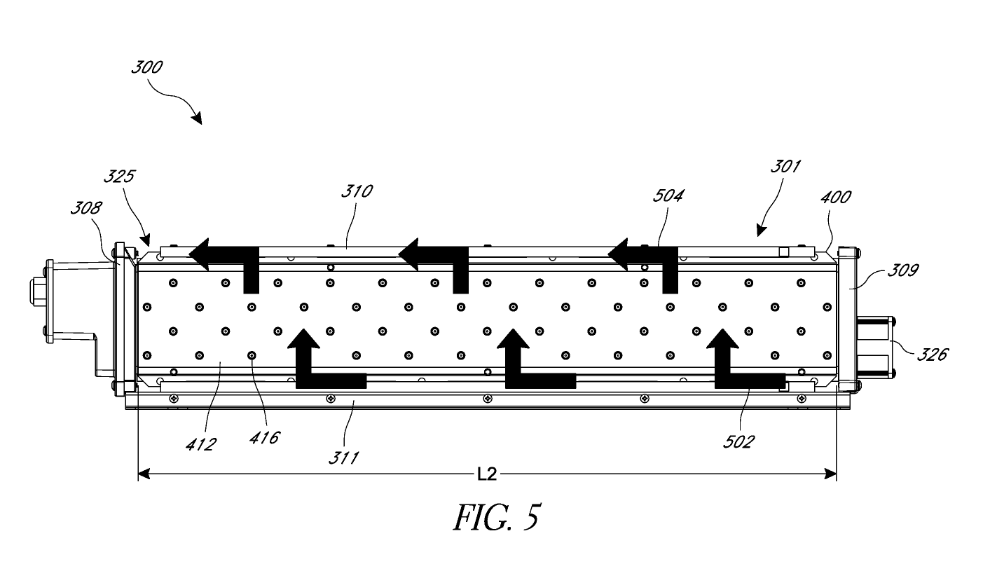

To calculate A1, a cross-sectional area of one of the spaces between adjacent sub-modules 400 may first be determined by multiplying the separation length (L1) with a dimension (L2) of the sub-modules 400 perpendicular or substantially perpendicular to that of the separation length L1. A cross-sectional area of a space between two adjacent sub-modules 400 extends perpendicular or substantially perpendicular to the plane along which the cross-sectional view of FIG. 4 extends. For example, the cross-sectional area extends into and out of the page of the cross-sectional view shown in FIG. 4. L2 is shown in FIG. 5 and as shown, L2 extends between an edge of the sub-module 400 proximate to the front cover 308 and an opposing edge proximate to the back cover 309. Thus, L2 is approximately a length of the energy storage sub-module 400. Accordingly, a cross-sectional area of one space between two adjacent sub-modules 400 is L1×L2, where L1 is as shown in FIG. 4 and L2 is as shown in FIG. 5. Thus, the total cross-sectional area A1 is the combined area for spaces between all adjacent sub-modules 400. In some embodiments, the adjacent sub-modules 400 can be evenly spaced apart within the module 300 and the sub-modules 400 can have the same configuration (e.g., the same dimensions, such as the same length). In such embodiments, the total cross-sectional area A1 of the spaces between adjacent sub-modules 400 can be determined by multiplying the aforementioned cross-sectional area L1×L2 for a single space between adjacent sub-modules 400 by N−1, where N is the number of sub-modules 400. For example, the total cross-sectional area of the spaces between adjacent sub-modules 400 can be determined using the following formula: (L1×L2)×(N−1). It will be understood that the total cross-sectional area A1 could include an additional area between the outermost sub-modules and the corresponding side portions of the module cover, in configurations in which airflow is permitted therebetween.

In some embodiments, the sub-modules 400 can be positioned at the same distance from the top cover 310 of the module. In such embodiments, the total cross-sectional area A2 of the space between respective edges of the sub-modules 400 and the top cover 310 may be determined by multiplying a distance from the edges of the sub-modules 400 to an interior surface of the top cover 310 (L3 in FIG. 4), with a dimension of the module 300 extending between interior surfaces of the side covers 312, for example an interior width of the module 300 (L4 in FIG. 4). Thus, the total cross-sectional area A2 of the space between respective edges of the sub-modules 400 and the top cover 310 may be determined using the following: L3×L4. Thus, the ratio A1:A2 can be expressed as (L1×L2)×(N−1):(L3×L4).

In some embodiment, a ratio of the separation length (L1) between adjacent energy storage sub-modules 400 and the length of a sub-module 400 perpendicular or substantially perpendicular to the separation length (L2) can be selected to facilitate desired cooling while maintaining a compact module 300. In some embodiments, the ratio can be up to about 1:20. In some embodiments, the ratio can about 1:10 to about 1:20, including about 1:15 to about 1:20. In some embodiments, the ratio can be greater than about 1:20. For example, the ratio can be about 1:20 to about 1:50, including about 1:20 to about 1:25, about 1:20 to about 1:30; about 1:20 to about 1:35, about 1:20 to about 1:40, or about 1:20 to about 1:45. Without being limited by any particular theory or mode of operation, a ratio of about 1:10 to about 1:50, for example about 1:20, between the separation length (L1) and the energy storage sub-module dimension perpendicular or substantially perpendicular to the separation length (L2) may facilitate development of a boundary layer in the air flow through the energy module 300, facilitating air flow across the width of the energy storage sub-module 400. For example, development of a boundary layer may facilitate increased contact between the air and exterior surfaces of the energy storage sub-module 400, thereby providing improved heat transfer away from the energy storage sub-module 400.

FIG. 5 shows a side cross-sectional view along a length of the energy storage module 300, for example, of FIG. 2A. FIG. 5 shows the energy storage sub-module 400 positioned within an enclosure formed, at least in part, by the front cover 308, back cover 309, top cover 310, and bottom cover 311 of cover 301 of the energy storage module 300. In FIG. 5, a side plan view of the energy storage sub-module 400 is shown, the energy storage sub-module 400 including a side plate, for example side plate 412, having a plurality of protrusions 416 distributed across a surface of the side plate 412 exterior to the sub-module 400.

The embodiment in FIG. 5 includes a cross-sectional view of an air flow generator, for example a first air flow generator 326, coupled to the back cover 309 of the module 300, and configured to draw air through the cover 301 and propel the air through the energy storage module 300. For example, the air flow generator can be configured to propel the air across a portion of the sub-module 400, such as at least one of the side plates, with side plate 412 being shown. The air flow generator can be configured to draw an amount of air into the module 300 and to propel the air through the energy storage module 300 at a desired rate to facilitate desired cooling of the energy storage module 300 during operation of one or more energy storage devices 402 (FIGS. 3-4). For example, the air flow generator can be configured to draw an amount of air into the module 300 and propel the air through the energy storage module 300 at a velocity such that the air flow follows a flow path configured to increase contact with exterior surfaces of the energy storage sub-modules 400, thereby facilitating improved cooling of the energy storage module 300.

Referring again to FIG. 5, a first set of air flow arrows 502 and a second set of air flow arrows 504 show an example of an air flow pattern through the energy storage module 300, according to one embodiment. For example, air drawn into the energy storage module 300 by an air flow generator can initially flow into a first end of the module 300 (e.g., through back cover 309), and along a length of the energy storage sub-modules 400 (e.g., along a first side of the sub-module 400, such as along lower cover 311). The air can then flow across a width of the energy storage sub-modules 400. Heated air can then flow along a second, opposing side of the sub-module, such as along upper cover 310. Air can then exit the module 300 through openings in the second side, such as the plurality of openings 325 in top cover 310, and/or through the opposing end of the module 300, such as through the front cover 308.

One or more air flow generators can be coupled to the back cover 309 at an off-center position, for example to facilitate drawing air into the energy storage module 300 proximate to one edge of energy storage module 300 such that the air can subsequently flow across a width of the energy storage sub-modules 400, for example as shown by the air flow arrow 502. Subsequently, the air can flow to an opposing edge of the energy storage sub-modules 400, for example, as shown by the air flow arrows 504. Placement of the one or more air flow generators, configuration of the one or more air flow generators, a separation distance between adjacent energy storage sub-modules 400, and/or the positioning of the exit openings for the air flow, can be configured to reduce air flow directly along a linear or substantially linear path along lengths of the energy storage sub-modules 400. Placement of the one or more air flow generators, configuration of the one or more air flow generators, a separation distance between adjacent energy storage sub-modules 400, and/or the positioning of the exit openings for the air flow, can be configured to increase contact of the air with exterior surfaces of the energy storage device sub-modules 400. Increased contact between the air and the exterior surfaces of the energy storage sub-modules 400 may improve cooling by facilitating transfer of thermal energy away from the energy storage sub-modules 400.

In some embodiments, air can be introduced into the energy storage module 300 through a back of the energy storage module 300 and along a bottom of the energy storage module 300, such that the air flows across a width of energy storage sub-modules to a top of the energy storage module 300, and the air can subsequently be dispelled to an exterior of the energy storage module 300 through a plurality of openings on a front cover 308 of the energy storage module 300. In some embodiments, such a configuration facilitates a compact energy storage module 300 which can provide desired temperature control of within the energy storage module 300 during operation.

As described herein, a ratio of the total cross-sectional area of the separation between adjacent energy sub-modules 400 and the total cross-sectional area of the separation between opposing edges of the energy sub-modules 400 and the top cover 310 and bottom cover 311 of the energy storage module 300, can be selected to provide desired distribution of air flow through the energy storage module. For example, the ratio can be selected to provide a distribution of air flow to facilitate one or more air flow patterns described herein. For example, the ratio can be about 1:10 or greater. In some embodiment, a ratio of the separation length between adjacent energy storage sub-modules 400 and the dimension of a sub-module 400 perpendicular or substantially perpendicular to the separation length, such as the length of the sub-module 400, can be selected to facilitate one or more air flow patterns described herein. For example, the ratio of about 1:20 may facilitate one or more flow patterns described herein.

In some embodiments, providing an air flow pattern within the energy storage module 300 as described herein may facilitate providing an operating temperature difference of no more than about 10° C., about 5° C., about 4° C., about 3° C. or about 2° C., between a temperature of an energy storage device 402 proximate to the end of the energy storage sub-module 400 adjacent to the air flow generators, and a temperature of an energy storage device 402 proximate to the second opposing end of the energy storage sub-module 400. In some embodiments, providing an air flow pattern as described herein may facilitate maintaining each energy storage device at a temperature of up to about 55° C. during operation of the energy storage devices. In some embodiments, providing an air flow pattern as described herein may facilitate maintaining a temperature of a space interior of the storage module 300 and exterior of the energy storage sub-module 400 at about 40° C. or less.

In some embodiments, air flow through the energy storage module 300 can include flowing air from one end of the module 300, such as the front end 302 or the back end 303, and propelling the air through the module 300. Such air may change in temperature (e.g., be heated by) based on temperature of the energy sub-modules 400, as it is flowed to an opposing end and then back to the same end. In some embodiments, air can be drawn into and expelled from the energy storage module 300 through a same portion of the energy storage module 300. For example, air can be drawn into the energy storage module 300 by one or more air flow generators coupled to a back cover 309 of the energy storage module 300, flowed through the module 300 from the back end 303 to the front end 302, and then from the front end 302 to the back end 303 such that the air can be expelled from the energy storage module 300 through openings on the same (e.g., back) cover. One or more configurations described herein may facilitate desired air flow through such a module 300, for example providing uniformly distributed air flow and/or desired air flow pattern, to provide the desired temperature control for the sub-modules 400.

FIG. 6A shows a perspective view of a portion of the energy storage device sub-module 400 of FIG. 3. The sub-module 400 includes an adhesive sheet 440 in each of the four receiving recesses 450 on a first side of the carrying tray 404. The adhesive sheet 440 may facilitate securing an energy storage device within the receiving recess 450. For example, the sub-module 400 may include eight adhesive sheets 440, one adhesive sheet 440 in each of the four receiving recesses 450 on the first side of the carrying tray 404, and in each of four receiving recesses 450 on a second opposing side of the carrying tray 404 (not shown in FIG. 6A). The adhesive sheet 440 can include adhesive material on both sides of the adhesive sheet 440 such that a first adhesive side can facilitate adhesion of the adhesive sheet 440 to a surface of the receiving recess 450 and a second opposing adhesive side of the adhesive sheet 440 can facilitate adhesion to an energy storage device 402.

The adhesive sheet 440 can have various suitable shapes and/or sizes. In some embodiments, as shown in FIG. 6A, the adhesive sheet 440 can have a rectangular or substantially rectangular shape. In some embodiments, the adhesive sheet 440 may have a curved and/or rounded shape. The adhesive sheet 440 may be made of a variety of suitable materials, including a polymeric material which stable across operating temperatures within the energy storage sub-module 400. In some embodiments, the adhesive sheet 440 can comprise an adhesive tape, for example a double-sided adhesive tape.

FIG. 6B is an exploded view of the portion of the energy storage sub-module 400 shown in FIG. 6A. Referring to FIGS. 6A and 6B, the sub-module 400 can include cell balancing device 430. The cell balancing device 430 can extend along a length of the carrying tray 400, and include a cell balancing board 436 at one end. For example, the cell balancing board 436 can be positioned adjacent a first end 406 of the carrying tray 404. As described herein, the carrying tray 400 may include a protrusion 462 on raised portions 460 separating adjacent receiving recesses 450. The cell balancing device 430 may include loop components 432 configured to be placed around the raised portions 460 of the carrying tray. Each loop component 432 may include two opening 434 on opposing portions configured to be placed over the protrusions 462 on opposing sides of the raised portion 460 of the carrying tray 404. Placement of the opening 434 over the protrusion 462 can facilitate coupling of the cell balancing device 430 with the energy storage devices 402 of the sub-module 400. For example, the carrying tray 404 can include three protrusions 460 on each opposing side of the carrying tray 404 to separate four receiving recesses 450 on each side, each of the protrusions 460 including a protrusion 462 over which a corresponding opening 434 on a loop component 432 of the balancing device 430 can be placed. Such a configuration may facilitate coupling of the cell balancing device 430 to each of eight energy storage devices seated in respective receiving recesses 450, and/or to securely positioning the cell balancing device 430 relative to the carrying tray 404 and/or energy storage devices 402. In some embodiments, the protrusions 462 can be subsequently deformed to form a fastener to fasten together the cell balancing device 430, the energy storage devices and/or the carrying tray 404, as will be described in more detail herein.

The loop component 432 may have a shape and a size configured to fit over a corresponding portion 462 of the carrying tray 404 while facilitating securing the cell balancing device 430 at a desired position relative to the carrying tray 404. For example, a diameter of a loop component 432 can be sized such that the loop component 430 fits tightly over the corresponding raised portion 460 of the carrying tray 404.

In some embodiments, the carrying tray 404 can include openings 456 extending along a bottom of each receiving recess 450. In some embodiments, the openings 456 may be configured to hold a portion of the cell balancing device 430. As described herein, the cell balancing device 430 may extend along a length of the carrying tray 404 and can be configured to facilitate electrical coupling between cell balancing device 430 and each of the energy storage devices 402 seated in respective receiving recesses 450 of the carrying tray 404. As shown in FIG. 6B, a portion of the cell balancing device 430 may be placed within openings 456 along bottoms of receiving recesses 450 in the carrying tray 404. Such a configuration may facilitate coupling of the energy storage devices 402 to the cell balancing device 430.

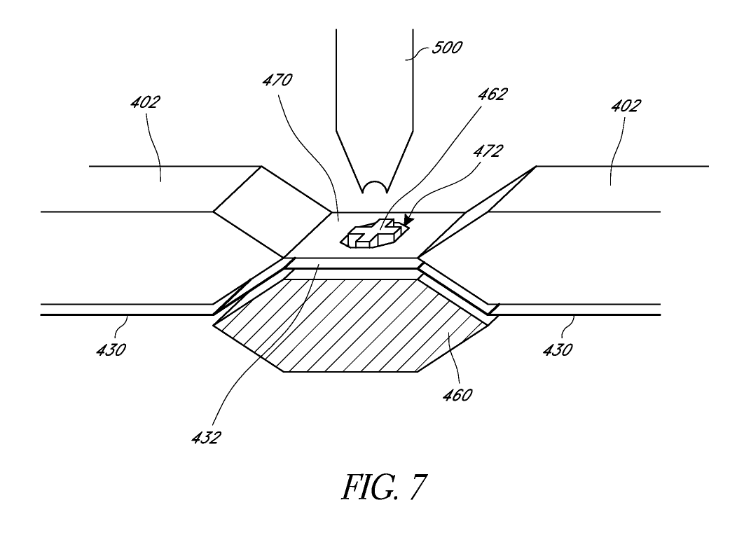

Referring to FIG. 7, a portion of the raised portion 460 of a carrying tray 404, a cell balancing device 430 and two adjacent energy storage devices 402 seated on either side of the raised portion 460 are shown. As described herein, the cell balancing device 430 may be coupled to an energy storage device 402 at a raised portion 460 of the carrying tray 404. As shown in FIG. 7, and as described herein, the cell balancing device 430 can include a loop component 432 having an opening 434 configured for placement over and around a protrusion 462 on the raised portion 460. Adjacent energy storage devices 402 may be coupled to one another through a connector portion 470. The connector portion 470 can include an opening 472 configured for placement over and around the protrusion 462 on the raised portion 460 of the carrying tray 404. For example, as shown in FIG. 7, the loop component 432 of the cell balancing device 430 may be placed over the raised portion 460 of the carrying tray 404 such that an opening 434 in the loop component 432 is placed over the protrusion 462. The connector portion 470 of adjacent energy storage devices 402 can be placed over the loop component 432, such that the opening 472 of the connector portion 470 is placed over the protrusion 462.

In some embodiments, subsequent to placement of the opening 434 of the loop component 432 and the opening 472 of the connector portion 470 over the protrusion 462 on the raised portion 460, the protrusion 462 can be reformed into a fastener to fasten the connector portion 470, the loop component 432 of the cell balancing device 430 and the raised portion 460 of the carrying tray 404 to one another. In some embodiments, the protrusion 462 can be remolded into a rivet to pin the cell balancing device 430 and the connector portion 470 to one another. For example, the balancing device 430 can be electrically coupled to the energy storage devices 402 via the connector portion 470. In some embodiments, such a configuration can facilitate securing of the carrying tray 404, the cell balancing device 430 and/or the energy storage devices 402 at desired positions relative to one another.

As shown in FIG. 7, a heat source 500 can be applied to the raised protrusion 462 of the carrying tray 404 after the loop component 432 of the cell balancing device 430 and the connector portion 470 between adjacent energy storage devices 402 have been placed over and around the protrusion 462 in the carrying tray 404. Various heat sources may be suitable, including for example, a laser heat source. In some embodiments, the protrusion 462 can comprise a polymeric material, including a polymeric material susceptible to deformation upon application of heat. For example, the protrusion 462 may comprise a thermoplastic material, facilitating remolding of the protrusion 462 at increased temperatures into a fastener for riveting together the cell balancing device 430 and the connector portion 470 between adjacent energy storage devices 402. The protrusion 462 may be made of a material the same as or similar to that of the carrying tray 404. In some embodiments, the protrusion 462 can comprise or consist essentially of polypropylene.

The heat source 500 can be applied to the protrusion 462 such that the protrusion 462 can be heated near, to, or above a glass transition temperature of a thermoplastic protrusion 462 to facilitate remolding of the protrusion 462. In some embodiments, the heat source can be applied to a tip portion of the protrusion 462 to reduce exposure of the remainder of the sub-module 400 to heat from the heat source. Once the protrusion 462 is sufficiently malleable, a force, for example a compressive force, can be applied upon the protrusion 462 to press the protrusion 462 down toward the carrying tray 404. The application of compressive force upon the protrusion 462 can transform the protrusion 462 into a fastener which can tightly fasten together the cell balancing device 430, the connector portion 470 and the carrying tray 404.

Although this invention has been disclosed in the context of certain embodiments and examples, it will be understood by those skilled in the art that the invention extends beyond the specifically disclosed embodiments to other alternative embodiments and/or uses of the invention and obvious modifications and equivalents thereof. In addition, while several variations of the embodiments of the invention have been shown and described in detail, other modifications, which are within the scope of this invention, will be readily apparent to those of skill in the art based upon this disclosure. It is also contemplated that various combinations or sub-combinations of the specific features and aspects of the embodiments may be made and still fall within the scope of the invention. It should be understood that various features and aspects of the disclosed embodiments can be combined with, or substituted for, one another in order to form varying modes of the embodiments of the disclosed invention. Thus, it is intended that the scope of the invention herein disclosed should not be limited by the particular embodiments described above.

The headings provided herein, if any, are for convenience only and do not necessarily affect the scope or meaning of the devices and methods disclosed herein.

What is claimed is:

1. An energy storage system, comprising:
a plurality of energy storage sub-modules adjacent one another and configured to be contained within a cover forming a portion of an energy storage module, each of the plurality of energy storage sub-modules comprising:
a carrying tray having a proximal end and a second opposing distal end;
a plurality of prismatic energy storage devices positioned longitudinally along the carrying tray with respect to each other;
an insulator sleeve surrounding the plurality of prismatic energy storage devices; and
a pair of side plates, a first of the pair of side plates adjacent a first side of the insulator sleeve and a second of the pair of side plates adjacent a second opposing side of the insulator sleeve, wherein at least one of the pair of side plates comprises a plurality of protrusions distributed across and protruding from an exterior surface of the at least one of the pair of side plates,
wherein the module is configured, in response to a pressure drop across the plurality of sub-modules, to draw air through the cover and propel air flow across the exterior surface of the at least one of the pair of side plates.

2. The energy storage system of claim 1, wherein at least one of the plurality of prismatic energy storage devices comprises a lithium ion capacitor.

3. The energy storage system of claim 1, wherein at least one of the plurality of prismatic energy storage devices comprises a lithium ion battery.

4. The energy storage apparatus of claim 1, wherein the plurality of protrusions is configured to maintain a separation length between adjacent energy storage sub-modules.

5. The energy storage apparatus of claim 4, wherein a ratio of the separation length to a length of the energy storage sub-module perpendicular in direction to that of the separation length is 1:10 to 1:50.

6. The energy storage apparatus of claim 1, wherein at least one of the plurality of prismatic energy storage devices comprises a pouch cell configuration.

7. The energy storage system of claim 6, wherein the insulator sleeve is configured to provide a compressive force upon the at least one of the plurality of prismatic energy storage device.

8. The energy storage system of claim 6, further comprising a sealing cap over the insulator sleeve and over the proximal end and the second opposing distal end of the carrying tray, wherein the sealing caps and the insulator sleeve hermetically seal the plurality of prismatic energy storage devices within a dust-free environment.

9. The energy storage system of claim 6, wherein the pair of side plates are fastened to one another to provide a compressive force upon the plurality of prismatic energy storage devices.

10. The energy storage system of claim 6, wherein the pair of side plates comprises a metallic material.

11. The energy storage system of claim 10, wherein the pair of side plates comprises aluminum.

12. The energy storage system of claim 1, wherein the module is configured to generate an air flow pattern through the module such that the plurality of prismatic energy storage devices each operate between a temperature of 20° C. to 55° C.

13. The energy storage system of claim 1, wherein each module includes an air flow generator configured to provide the pressure drop.

14. A motor vehicle powered by the energy storage system of claim 1.

15. The motor vehicle of claim 14, wherein the motor vehicle comprises an automobile.

16. The motor vehicle of claim 14, wherein the energy storage system is configured to provide an operating voltage of 200 Volts to 400 Volts.

17. An energy storage system, comprising:
an energy storage module, the energy storage module comprising:
a cover providing a space for receiving a plurality of energy storage sub-modules, wherein the cover comprises a top cover portion;
a plurality of energy storage sub-modules adjacent one another received within the space and forming a space between the sub-modules and the top cover portion,
wherein a ratio of a total first cross-sectional area A1 to a total second cross-sectional area A2 is 1:10 to 1:40, wherein A1 is a combined total of all the cross-sectional areas between the adjacent energy storage sub-modules, each cross-sectional area between two adjacent energy storage sub-modules defined as a separation length L1 between the two adjacent sub-modules multiplied by a length L2 of the two adjacent sub-modules, and A2 is a total cross-sectional area of the space between the plurality of energy storage sub-modules and the top cover portion, wherein A2 is defined as a distance L3 from the edges of the sub-modules to an interior surface of the top cover portion multiplied by an interior width of the module L4.

18. The energy storage system of claim 17, further comprising:
a carrying tray having a proximal end and a second opposing distal end;
a plurality of energy storage devices positioned longitudinally within the carrying tray with respect to one another;
an insulator sleeve surrounding the plurality of energy storage devices; and
a pair of side plates, a first of the pair of side plates adjacent a first side of the insulator sleeve and a second of the pair of side plates adjacent a second opposing side of the insulator sleeve, wherein at least one of the pair of side plates comprises a plurality of protrusions distributed across an exterior surface.

19. The energy storage system of claim 18, wherein the plurality of energy storage devices comprises a pouch cell configuration.

20. The energy storage system of claim 19, further comprising a sealing cap over the insulator sleeve and over the proximal end and the second opposing distal end of the carrying tray, wherein the sealing caps and the insulator sleeve hermetically seal the energy storage devices within a dust-free environment.

21. The energy storage system of claim 19, wherein the pair of side plates are fastened to one another to provide a compressive force upon the plurality of energy storage devices.

22. The energy storage system of claim 18, wherein the plurality of energy storage devices comprises a string of energy storage devices wrapped around the carrying tray, wherein at least one of the plurality of energy storage devices is positioned on a first side of the carrying tray and at least one of the plurality of energy storage devices is positioned on a second opposing side of the carrying tray, a connection portion between the at least one of the plurality of energy storage devices on the first side and second of the carrying tray being wrapped around the second opposing distal end of the carrying tray.

23. The energy storage system of claim 22, further comprising an air flow generator configured to propel air flow from a distal end of the energy storage module to a proximal end of the energy storage module, wherein the distal end of the energy storage module is proximate to the second opposing distal end of the carrying tray and the proximal end of the energy storage proximate to the proximal end of the carrying tray.

24. The energy storage system of claim 23, further comprising at least two energy storage devices positioned on each of the first and second side of the carrying tray, wherein an energy storage device positioned on the carrying tray proximate to the proximal end of the carrying tray is configured to have an operating temperature no more than 3° C. greater than an operating temperature of an energy storage device positioned on the carrying tray proximate to the distal end of the carrying tray.
